(19) United States
(12) Patent Application Publication
(10) Pub. No.: US 2003/0026115 A1
(43) Pub. Date: Feb. 6, 2003

(54) Switching-type DC-DC converter

(76) Inventor: Takahiro Miyazaki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/255,059

(22) Filed: Sep. 24, 2002

Related U.S. Application Data
(63) Continuation of application No. PCT/JP00/02650, filed on Apr. 21, 2000.

(51) Int. Cl. H02H 7/125

(52) U.S. Cl. 363/53

(57) ABSTRACT

According to a switching-type DC-DC converter of the present invention, a switching element (MOSFET, etc.) on the primary side for converting a DC input voltage into an AC voltage is subjected to switching operation according to a first control signal of a fixed frequency and a fixed ON/OFF ratio, and also a switching element (MOSFET, etc.) on the secondary side for rectifying the AC voltage is subjected to switching operation according to a second control signal in synchronism with a delay signal obtained by delaying the first control signal by a predetermined period of time, to realize a so-called zero-cross switch in the switching element on the primary side. Thus, the power loss due to a response time of the switching element is decreased.

### This application is a continuation of PCT/JP00/02650, filed on Apr. 21, 2000.

### TECHNICAL FIELD

The present invention relates to a switching-type DC-DC converter that converts a DC input voltage into an AC voltage through switching, and rectifies and smoothes the AC voltage to obtain a DC output voltage. More particularly, the invention relates to a switching-type DC-DC converter that switches the input voltage by using an active element.

### BACKGROUND ART

A switching-type DC-DC converter is to obtain an output voltage by converting a DC input voltage into an AC voltage by the ON/OFF operation of a switching element, lowering or raising the AC voltage to a required voltage by a transformer, and then converting an AC output of the transformer into a DC voltage by a rectifier circuit and a smoothing circuit. The switching-type DC-DC converter is widely used as a power source and the like for various kinds of equipment.

FIG. 8 is a circuit diagram showing the constitution of a conventional switching-type DC-DC converter.

In a conventional circuit configuration as shown in FIG. 8, a MOSFET 102 being a switching element is connected in series with the primary side of a transformer 101, an input filter 103 consisting of capacitors 103A and 103B is connected to the primary side of the transformer 101, a DC input voltage Vi applied to input terminals IN is converted into an AC voltage by the switching operation of the MOSFET 102, and the AC voltage is lowered or raised to a required voltage by the transformer 101. To the secondary side of the transformer 101, there are connected a rectifier circuit 104 consisting of a diode 104A for rectification and a diode 104B for commutation, and a smoothing circuit 105 consisting of a choke coil 105A and capacitors 105B, 105C. An AC output of the transformer 101 is rectified and smoothed by the rectifier circuit 104 and the smoothing circuit 105, so that a DC output voltage Vo is output from output terminals OUT. A value of the DC output voltage Vo is determined depending on a voltage value output from the transformer 101 and a ratio of the ON/OFF times of the MOSFET 102.

Further, in order to stably maintain the output voltage Vo at a constant value, the circuit configuration of FIG. 8 incorporates therein a control circuit 106 that monitors the output voltage Vo, and performs the control operation to lower the output voltage Vo when it rises and to raise the output voltage Vo when it drops. The above control operation is usually performed by adjusting the rise or drop of the output voltage Vo by changing the ON/OFF ratio of the MOSFET 102 by using, for example, a pulse width control circuit (PWM) or the like. Therefore, the MOSFET 102 works to convert the DC input voltage Vi into an AC voltage to apply it to the transformer 101, and further exhibits a function to adjust the output voltage Vo depending on the ON/OFF ratio.

With the above-mentioned conventional switching-type DC-DC converter, however, a large power loss occurs due to a delay time caused in the switching element. That is, the active element such as a transistor or a MOSFET to be used as a switching element requires a rise time or a fall time when it is turned ON or OFF. Therefore, there occurs such a state in which the voltage does not become zero even when the switching element has been turned ON and the current has started flowing, or the current continues to flow even when the switching element has been turned OFF and the voltage has risen.

Specifically, in the above-mentioned circuit configuration shown in FIG. 8, when the ON/OFF state of the MOSFET 102 is switched at the timing as shown in (a) of FIG. 9, a drain-source voltage Vds of the MOSFET 102 is changed as shown in (b) of FIG. 9, and a current Id that flowing into a channel of the MOSFET 102 is changed as shown in (c) of FIG. 9. As for the changes in the voltage Vds and the current Id of when the MOSFET 102 is turned ON or OFF, as shown in an enlarged view of FIG. 10, the voltage Vds does not become zero even when the MOSFET 102 has been turned ON and the current Id has started flowing and, further, the current Id continues to flow even when the MOSFET 102 has been turned OFF and the voltage Vds has risen. Therefore, there occurs a power loss as represented by hatched portions in FIG. 10. The power loss accounts for 20 to 30% of a power loss that occurs in the whole switching-type DC-DC converter. Since the power loss in the switching element causes, for example, the temperature to rise, it becomes necessary to cool the switching element by using a heat-radiating board or the like.

In order to prevent an increase in the power loss in the switching element on the primary side, it is enough to avoid a state in which the voltage Vds and the current Id are produced simultaneously due to a delay in the operation of the switching element. Namely, it is necessary to realize a so-called zero-cross switch for turning the switching element ON and OFF in a state in which the voltage Vds and the current Id are both zero.

The present invention has been accomplished by giving attention to the above-mentioned point, and has an object of providing a simply constituted low-loss switching-type DC-DC converter designed for decreasing the power loss by the switching operation as a result of realizing a zero-cross switch.

As prior art having an object for decreasing the loss of the switching-type DC-DC converter, there has been known a rectifier circuit disclosed in Japanese Unexamined Patent Publication No. 4-127869. According to this prior art, a MOSFET is used as a rectifying element, and in performing the rectification by controlling the MOSFET in synchronism with a main switch drive signal on the primary side, it is judged whether the timing for turning the MOSFET OFF is proper or not. If the timing is not proper, the delay time for driving the MOSFET is adjusted to a direction in which the timing becomes proper, so that the loss does not occur. However, this prior art cannot realize a decrease in the power loss occurred in the switching element on the primary side and, hence, has an object, mode of operation and effect that are different from those of the present invention.

### DISCLOSURE OF THE INVENTION

A switching-type DC-DC converter according to the present invention comprises AC converting means for converting a DC input voltage into an AC voltage by the ON/OFF operation of a switching element, transforming means for transforming the voltage that has been converted into the AC voltage by the AC converting means, rectifying means for rectifying the voltage transformed by the transforming means, and smoothing means for smoothing the voltage rectified by the rectifying means to output a DC output voltage;

wherein the AC converting means includes a switching unit that uses an active element as the switching element, and a first control signal generating unit that generates a first control signal for switching the active element in the switching unit at a fixed frequency and at a fixed ON/OFF ratio; and the rectifying means includes a rectifying unit that uses an active element as a rectifying element to rectify the voltage transformed by the transforming means, a commutating unit that commutates a current generated by the energy stored in the smoothing means when the active element in the rectifying unit is turned OFF, a delay unit that generates a delay signal obtained by delaying the first control signal output from the first control signal generating unit by a time longer than a response time of the active element in the switching unit, and a second control signal generating unit that generates a second control signal for turning the active element in the rectifying unit ON in synchronism with the delay signal from the delay unit, the second control signal being adjusted for its ON/OFF ratio so that the output voltage smoothed by the smoothing means becomes a preset value, and an ON-continuation time of the second control signal being set to be shorter than a time obtained by subtracting the delay time in the delay unit from an ON-continuation time of the first control signal.

According to the above constitution, the active element in the switching unit is subjected to the switching operation according to the first control signal having the fixed frequency and the fixed ON/OFF ratio, whereby the DC input voltage is converted into an AC voltage. At this time, the current to flow through the active element in the switching unit starts flowing only when the active element in the rectifying unit is turned ON. Therefore, the current starts flowing when a predetermined delay time in the delay unit has elapsed after the active element in the switching unit has been turned ON. The delay time is set to be longer than the response time of the active element in the switching unit and, hence, a zero-cross switch is realized when the active element in the switching unit is turned ON. Further, since the ON-continuation time of the second control signal is set to be shorter than a time obtained by subtracting the delay time in the delay unit from the ON-continuation time of the first control signal, the active element in the rectifying unit is turned OFF before the active element in the switching unit is turned OFF. Therefore, the current flowing through the active element in the switching unit ceases to flow before that active element is turned OFF. Accordingly, the zero-cross switch is realized even when the active element in the switching unit is turned OFF. The voltage converted into the AC voltage by the ON/OFF operation of the switching unit in which the thus zero-cross switch is realized, is transformed to a required voltage by the transforming means and is, then, converted into a DC output voltage by the rectifying means and the smoothing means. The DC output voltage is controlled to a preset value by adjusting the ON/OFF ratio of the active element in the rectifying unit according to the second control signal. Thus, since the power loss in the switching unit of the AC converting means is decreased, it becomes possible to decrease the loss in the switching-type DC-DC converter.

The switching-type DC-DC converter further comprises output detecting means for detecting an output voltage smoothed by the smoothing means, wherein the second control signal generating unit generates the second control signal of which ON/OFF ratio is adjusted according to the result detected by the output detecting means.

According to this constitution, since the ON/OFF ratio of the active element in the rectifying unit is feedback controlled according to the output voltage detected by the output detecting means, it becomes possible to obtain a stable output voltage.

In the above-mentioned switching-type DC-DC converter, further, the rectifying means includes the commutating unit constituted by an active element, and an inverting unit that inverts the second control signal output from the second control signal generating unit, and the active element in the commutating unit is subjected to the switching operation according to the second control signal inverted by the inverting unit.

According to this constitution, the active element in the commutating unit is subjected to the switching operation according to an inversion signal of the second control signal to commutate the current generated by the energy stored in the smoothing means when the active element in the rectifying unit is turned OFF. If a passive element is used in the commutating unit, the loss due to a forward direction voltage drop is increased. However, the loss in the commutating unit can be decreased if the active element is used instead of such a passive element, and thus it becomes possible to realize a switching-type DC-DC converter having smaller losses.

### BRIEF EXPLANATION OF DRAWINGS

FIG. 1 is a circuit diagram showing the constitution of a switching-type DC-DC converter according to a first embodiment of the present invention;

FIG. 2 is a timing diagram for explaining the operation of the first embodiment;

FIG. 3 is a circuit diagram showing the constitution of the switching-type DC-DC converter according to a second embodiment of the present invention;

FIG. 4 is a timing diagram for explaining the operation of the second embodiment;

FIG. 5 is a circuit diagram showing the constitution of the switching-type DC-DC converter according to a third embodiment of the present invention;

FIG. 6 is a timing diagram for explaining the operation of the third embodiment;

FIG. 7 is a circuit diagram of a case where the constitution same as that of the third embodiment is applied to the second embodiment;

FIG. 8 is a circuit diagram showing the constitution of a conventional switching-type DC-DC converter;

FIG. 9 is a timing diagram for explaining the switching operation of the conventional switching-type DC-DC converter; and

FIG. 10 is a diagram showing, in an enlarged scale, changes in the voltage and in the current of when the switching element is turned ON and OFF in FIG. 9.

### BEST MODE FOR CARRYING OUT THE INVENTION

A switching-type DC-DC converter according to the present invention will now be described with reference to the accompanying drawings.

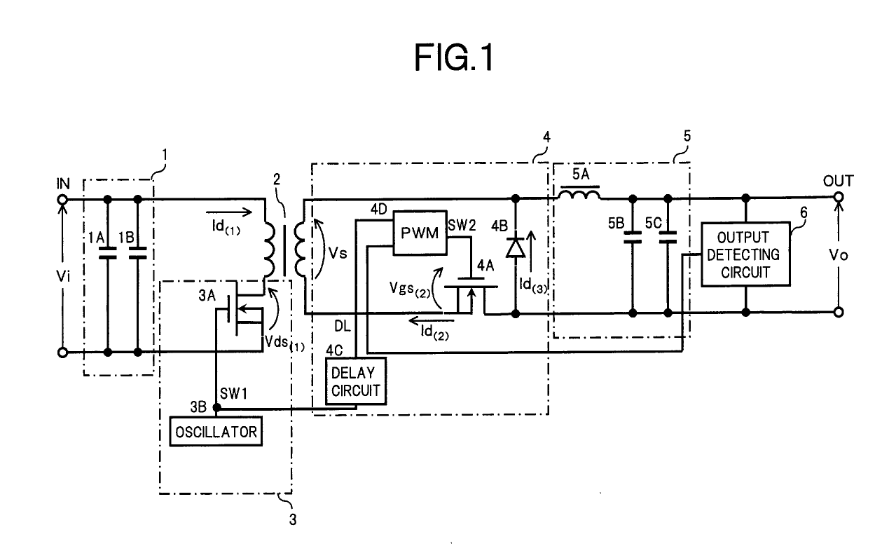

FIG. 1 is a circuit diagram illustrating the constitution of a switching-type DC-DC converter according to a first embodiment of the present invention.

In FIG. 1, the switching-type DC-DC converter includes input terminals IN to which, for example, a DC input voltage Vi is applied, an input filter circuit 1 which receives the input voltage Vi applied to the input terminals IN, a transformer 2 being transforming means that receives an output of the input filter circuit 1 on the primary side thereof, a switching circuit 3 being AC converting means connected in series with the primary side of the transformer 2, a rectifier circuit 4 being rectifying means that receives an output voltage Vs from the secondary side of the transformer 2, a smoothing circuit 5 being smoothing means that is applied with an output voltage of the rectifier circuit 4, output terminals OUT applied with a DC output voltage Vo from the smoothing circuit 5, and an output detecting circuit 6 being output detecting means that detects the output voltage Vo to feed it back to the rectifier circuit 4.

The input filter circuit 1 is constituted by, for example, two capacitors 1A and 1B connected in parallel with each other between the input terminals IN. The transformer 2 has a primary coil of a number of turns n₁ and a secondary coil of a number of turns n₂, one end of the primary coil being connected to commonly connected electrodes on one side of the capacitors 1A and 1B.

The switching circuit 3 is constituted by a MOSFET 3A being a switching unit and an oscillator 3B being a first control signal generating unit. The MOSFET 3A has a drain terminal connected to the other end of the primary coil, and has a source terminal connected to commonly connected electrodes on the other side of the capacitors 1A and 1B. The oscillator 3B oscillates at a fixed frequency and a fixed pulse width (ON/OFF ratio) to generate a first control signal SW1. The first control signal SW1 is applied to a gate terminal of the MOSFET 3A to control the switching operation of the MOSFET 3A, and is also sent to the rectifier circuit 4.

The rectifier circuit 4 is constituted by a MOSFET 4A being a rectifying unit, a diode 4B being a commutating unit, a delay circuit 4C being a delay unit, and a pulse width control circuit (PWM) 4D being a second control signal generating unit. The MOSFET 4A has a source terminal connected to one end of the secondary coil of the transformer 2, and has a drain terminal connected to an anode terminal of the diode 4B. The diode 4B has a cathode terminal connected to the other end of the secondary coil of the transformer 2. As will be described later, the diode 4B functions as a commutating diode for releasing the energy accumulated in the smoothing circuit 5 to the output terminal OUT when the MOSFET 4A is OFF. The delay circuit 4C receives the first control signal SW1 output from the oscillator 3B, generates a delay signal DL obtained by delaying the first control signal SW1 by a fixed period of time to output it to the pulse width control circuit 4D. The setting of delay time in the delay circuit 4C will be described later. The pulse width control circuit 4D generates, based on the delay signal DL sent to one input terminal thereof from the delay circuit 4 and on an output detection signal sent to the other input terminal thereof from the output detecting circuit 6, a second control signal SW2, which is in synchronism with the frequency of the AC voltage generated on the primary side and controls the ON/OFF ratio of the MOSFET 4A so that the output voltage Vo becomes a required value. The second control signal SW2 is applied to a gate terminal of the MOSFET 4A to control the switching operation of the MOSFET 4A.

The smoothing circuit 5 is constituted by, for example, a choke coil 5A and capacitors 5B, 5C. The choke coil 5A is connected at its one end to the cathode terminal of the diode 4B. The other end of the choke coil 5A is connected to commonly connected electrodes on one side of the capacitors 5B, 5C, and the anode terminal of the diode 4B is connected to commonly connected electrodes on the other side of the capacitors 5B, 5C.

The output detecting circuit 6 detects the output voltage Vo of the smoothing circuit 5 to be applied to the output terminals OUT, and sends an output detection signal corresponding to the output voltage Vo to the other input terminal of the pulse width control circuit 4D.

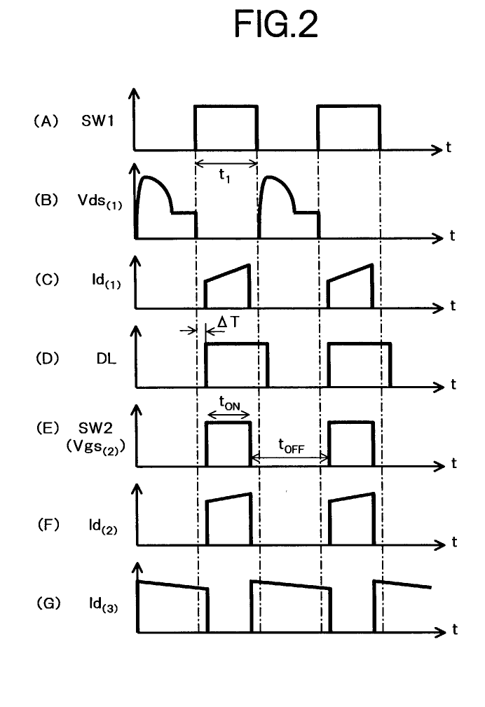

The operation of the first embodiment will now be described with reference to a timing diagram of FIG. 2.

In the switching-type DC-DC converter of the above-mentioned constitution, the first control signal SW1 of a fixed frequency and a fixed pulse width as shown in (A) of FIG. 2 is output from the oscillator 3B. The MOSFET 3A is turned ON or OFF according to the first control signal SW1, whereby the DC input voltage Vi applied to the input terminals IN and has passed through the input filter circuit 1, is converted into an AC voltage.

Specifically, when the first control signal SW1 has a low level and the MOSFET 3A is turned OFF, a drain-source voltage Vds₍₁₎ of the MOSFET 3A rises to be changed in a waveform as shown in (B) of FIG. 2. At this moment, a current Id₍₁₎ flowing through the channel of the MOSFET 3A is zero as shown in (C) of FIG. 2.

When the first control signal SW1 is changed to a high level and the MOSFET 3A is turned ON, the drain-source voltage Vds₍₁₎ of the MOSFET 3A becomes the zero level after a falling time (delay time) as shown in FIG. 10. On the other hand, the current Id₍₁₎ flowing through the channel of the MOSFET 3A does not readily flow even when the MOSFET 3A is turned ON, but starts flowing after the lapse of a fixed delay time. This is because the current Id₍₁₎ on the primary side starts flowing after there is established a state where the MOSFET 4A in the rectifier circuit 4 is turned ON and then a current flows even on the secondary side of the transformer 2. Accordingly, after the MOSFET 3A is turned ON, the timing at which the current Id₍₁₎ on the primary side rises is controlled by the timing at which the MOSFET 4A on the secondary side is turned ON, which is dependent on the setting of the delay circuit 4C.

As shown in (D) of FIG. 2, the delay signal DL output from the delay circuit 4C is a signal obtained by delaying the first control signal SW1 from the oscillator 3B by a time ΔT. The delay time ΔT is set to be longer than the falling time (see FIG. 10) of until the voltage Vds₍₁₎ becomes zero after the MOSFET 3A on the primary side is turned ON. The delay signal DL is sent to the pulse width control circuit 4D in which, as shown in (E) of FIG. 2, there is generated the second control signal SW2 which is in synchronism with the delay signal DL and of which ON/OFF ratio is changed so that the output voltage Vo represented by the output detection signal from the output detecting circuit 6 becomes a required value.

Setting of the ON/OFF ratio of the second control signal SW2 will now be specifically described.

In the circuit configuration of the present invention, the ON/OFF ratio in the switching operation on the primary side of the transformer 2 is fixed, and the ON/OFF ratio of the rectifier MOSFET 4A of just before being smoothed on the secondary side is controlled, to obtain a required DC output voltage Vo. Therefore, if an ON-continuation time of the MOSFET 4A is denoted by t_{ON}, an OFF-continuation time thereof by t_{OFF} and an output voltage on the secondary side of the transformer 2 by Vs, then, the output voltage Vo can be expressed by the following formula (1).

Vo=Vs×{t_{ON}/(t_{ON}+t_{OFF})} (1)

Further, by using the number of turns n₁ on the primary side, the number of turns n₂ on the secondary side and the input voltage Vi, the output voltage Vs on the secondary side of the transformer 2 can be expressed by the following formula (2).

Vs=Vi×(n₂/n₁) (2)

From the above formulas (1) and (2), the output voltage Vo possesses a relationship expressed by the following formula (3) relative to the input voltage Vi,

Vo=Vi×(n₂/n₁)×{t_{ON}/(t_{ON}+t_{OFF})} (3)

In the above formula (3), the input voltage Vi and the numbers of turns n₁, n₂ are preset values. In order for the output voltage Vo to be a required value, therefore, the ON/OFF ratio of the MOSFET 4A may be adjusted. Here, the output voltage Vo actually obtained is detected by the output detecting circuit 6, and the ON/OFF ratio of the MOSFET 4A is feedback controlled by the pulse width control circuit 4D by using the detected result.

The ON-continuation time t_{ON} of the MOSFET 4A should be so set as to become shorter than a time obtained by subtracting the delay time ΔT (see (D) of FIG. 2) of the delay circuit 4C from the ON-continuation time t₁ (see (A) of FIG. 2) of the MOSFET 3A on the primary side (t_{ON}<t₁−ΔT). To realize the above setting for the required output voltage Vo, the ratio of the numbers of turns of the transformer 2 may be suitably set in advance.

The second control signal SW2 thus generated by the pulse width control circuit 4D is applied to the gate terminal of the MOSFET 4A, and then, the MOSFET 4A performs the switching operation according to the second control signals SW2.

Specifically, when the second control signal SW2 has a low level and the MOSFET 4A is turned OFF, a current Id₍₂₎ flowing through the channel of the MOSFET 4A is zero as shown in (F) of FIG. 2. When the second control signal SW2 is changed to a high level and the MOSFET 4A is turned ON, the current Id₍₂₎ starts flowing after a rising time (delay time) as shown in FIG. 10. Simultaneously with the generation of current Id₍₂₎, the current Id₍₁₎ flowing through the channel of the MOSFET 3A on the primary side also starts flowing after a required rising time.

Further, when the second control signal SW2 is changed to the low level and the MOSFET 4A is turned OFF, the currents Id₍₁₎ and Id₍₂₎ flowing through the channels of the MOSFETs 3A and 4A on the primary side and on the secondary side, cease to flow after falling times as shown in FIG. 10. At a moment when the second control signal SW2 is changed to the low level, the first control signal SW1 is still at the high level and the MOSFET 3A is maintained ON. Accordingly, the drain-source voltage Vds₍₁₎ of the MOSFET 3A remains zero (see (B) of FIG. 2). Then, when the first control signal SW1 is also changed to the low level and the MOSFET 3A is turned OFF, the voltage Vds₍₁₎ rises again after the required rising time.

Thus, even when the MOSFET 3A on the primary side is turned ON, the current Id₍₁₎ flowing through the channel of the MOSFET 3A starts flowing with a delay since the MOSFET 4A on the secondary side is turned ON with a delay, and there is realized a so-called zero-cross switch capable of switching between zero current and zero voltage when the MOSFET 3A is switched ON: Further, since the ratio of the numbers of turns of the transformer 2 is so set that t_{ON}<t₁−ΔT, the MOSFET 4A on the secondary side is turned OFF before the MOSFET 3A on the primary side is turned OFF and, hence, the zero-cross switch is realized also when the MOSFET 3A is switched OFF.

The voltage converted into an AC voltage by the switching operation of the MOSFET 3A is lowered or raised to a required voltage by the transformer 2. The AC voltage Vs output from the secondary side of the transformer 2 is rectified through the MOSFET 4A that performs the switching operation according to the second control signals SW2 and through the commutating diode 4B. (G) of FIG. 2 shows a change with the time lapse in a current Id₍₃₎ flowing through the commutating diode 4B. The voltage output from the rectifier circuit 4 is smoothed by the smoothing circuit 5, to be output to the outside as a DC output voltage Vo through the output terminals OUT.

According to the first embodiment as described above, the switching operation of the rectifier MOSFET 4A is controlled according to the second control signal SW2 generated by delaying the first control signal SW1 to thereby realize the zero-cross switch in the MOSFET 3A on the primary side. Thus, it becomes possible to decrease the power loss of the switching element on the primary side and, hence, to realize a switching-type DC-DC converter with a simply structure and a low loss.

Next, a second embodiment of the present invention will be described.

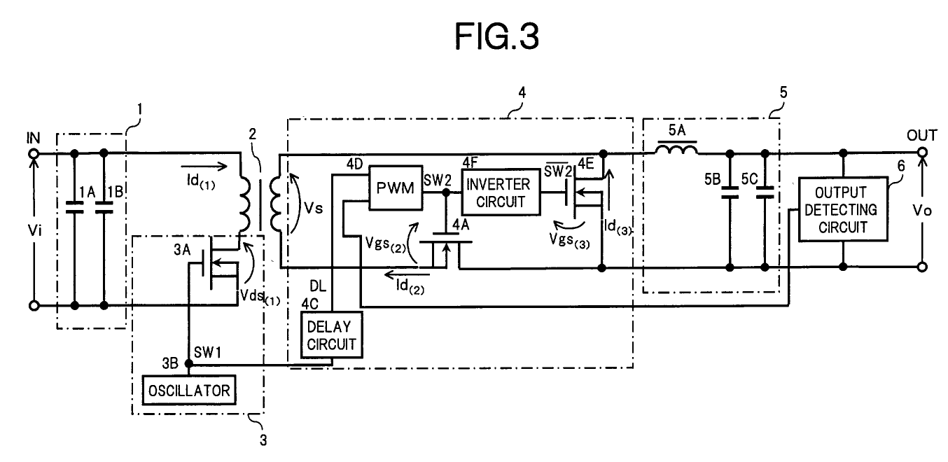

FIG. 3 is a circuit diagram illustrating the constitution of the switching-type DC-DC converter according to the second embodiment. Here, the same portions as those in the constitution of the first embodiment are denoted by the same reference numerals.

In FIG. 3, the portion in the constitution of the second embodiment different from that of the first embodiment is that, in the rectifier circuit 4, the commutating diode 4B is replaced by a MOSFET 4E, an inverter circuit 4F is provided as an inverting unit that inverts the second control signal SW2 output from the pulse width control circuit 4D, and the switching operation of the MOSFET 4E is controlled according to the second control signal SW2 inverted by the inverter circuit 4F. The constitution other than the above is the same as the constitution of the first embodiment, and the description thereof is omitted.

The MOSFET 4E has a source terminal connected to the drain terminal of the MOSFET 4A, has a drain terminal connected to a common contact point of the secondary coil of the transformer 2 and the choke coil 5A, and has a gate terminal connected to an output terminal of the inverter circuit 4F. The MOSFET 4E performs the switching operation according to an inversion signal of the second control signal SW2 to realize the same function as that of the commutating diode.

By replacing the commutating diode by the MOSFET 4A, a loss in the rectifier circuit 4 is decreased. That is, the diode, usually, has a forward direction voltage drop of a fixed value. The forward direction voltage drop is about 0.5V when the diode is used for generating an output of, for example, 5V or less. On the other hand, at present, it is possible to use a FET having an ON-resistance of, for example, about 10 mΩ. If the diode and the FET are simply compared, when the switching power source operating at a 50% ON/OFF ratio generates a power of 10 amperes, the diode causes a loss of 2.5 watts whereas the FET causes a loss of 0.5 watts. Thus, the loss can be greatly decreased by replacing the diode used in the rectifier circuit 4 by the FET.

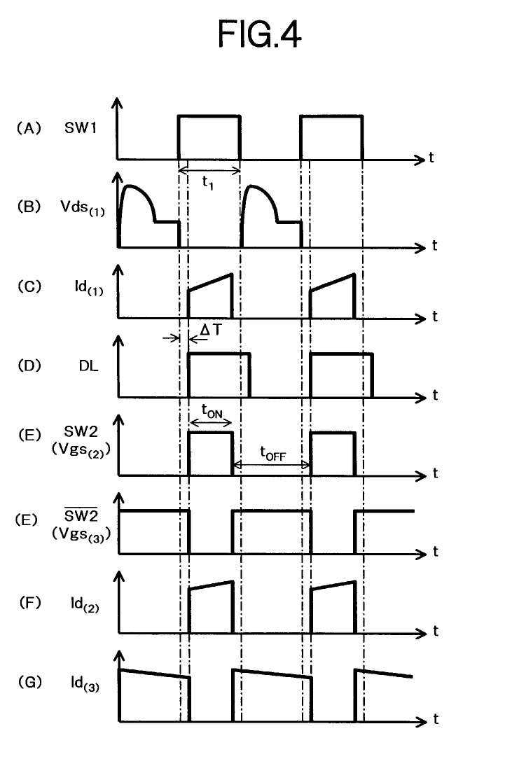

When the commutating diode is replaced by the MOSFET being an active element, it is required to control the ON/OFF state of the MOSFET from the external side. In the circuit configuration of the present invention, however, the ON/OFF of the MOSFET can be easily controlled. That is, according to the present invention, in the rectifier circuit 4, the MOSFET 4A is used for controlling the switching operation the rectifier diode side and, hence, the second control signal SW2 for controlling the MOSFET 4A can be easily utilized for controlling the operation of the commutating MOSFET 4E. Specifically, the commutating MOSFET 4E may be turned ON during a period in which the rectifier MOSFET4A is OFF. As shown in (E)′ of FIG. 4, therefore, the ON/OFF may be switched according to the signal obtained by inverting the second control signal SW2. The signal waveforms other than the one shown in (E)′ of FIG. 4 are the same as those of the first embodiment shown in FIG. 2, and the description thereof is omitted.

According to the second embodiment as described above, the commutating diode constituting the rectifier circuit 4 is replaced by the MOSFET 4E to decrease the loss in the rectifier circuit 4 and to further decrease the loss in the switching-type DC-DC converter.

Next, a third embodiment of the present invention will be described.

The third embodiment shows an example of more specific constitution of the above-mentioned first embodiment.

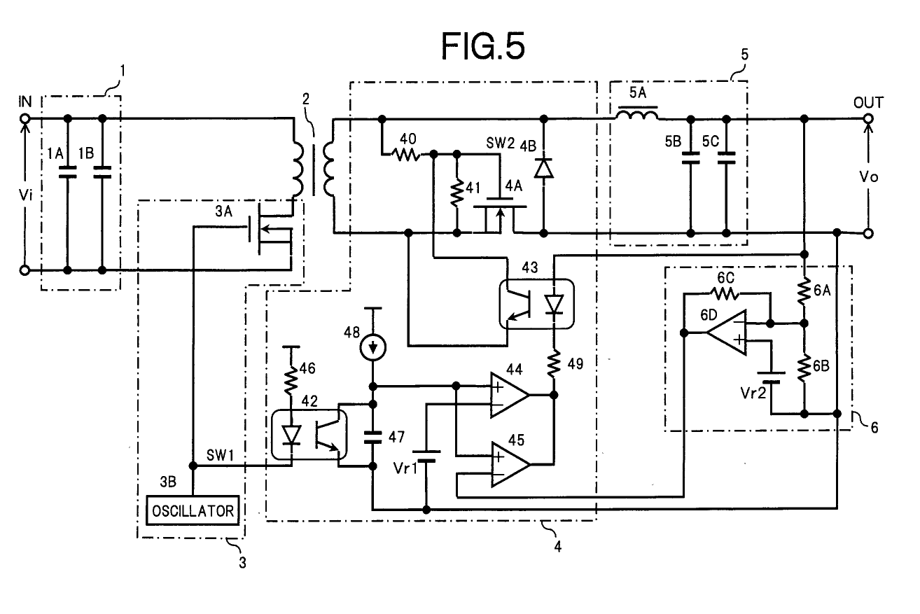

FIG. 5 is a circuit diagram illustrating the constitution of the switching-type DC-DC converter according to the third embodiment. Here, however, the same portions as those in the constitution of the first embodiment are denoted by the same reference numerals.

In FIG. 5, the present switching-type DC-DC converter is constituted by further embodying the constitutions of the rectifier circuit 4 and of the output detecting circuit 6 in the constitution of the above-mentioned first embodiment, while the input filter circuit 1, the transformer 2, the switching circuit 3 and the smoothing circuit 5 are constituted in the same manner as those of the first embodiment.

The rectifier circuit 4 is such that the MOSFET 4A and the commutating diode 4B are arranged in the same manner as those of the first embodiment, and two resistors 40 and 41 are connected in series between both terminals of the secondary coil of the transformer 2, and the gate terminal of the MOSFET 4A is connected to a common connection point of the resistors 40 and 41. The rectifier circuit 4 further has two photo-couplers 42, 43 and two comparators 44, 45. The photo-coupler 42 is connected at one end of a light-emitting portion thereof to the output terminal of the oscillator 3B and is connected at the other end of the light-emitting portion thereof to the power source terminal through a resistor 46. A timer capacitor 47 is connected between the output terminals of a light-receiving portion of the photo-coupler 42, one end of the timer capacitor 47 being connected to a constant-current source 48. The photo-coupler 43 is applied with the output voltage Vo at one end of a light-emitting portion thereof and is connected at the other end of the light-emitting portion thereof to respective output terminals of the comparators 44 and 45 through a resistor 49. A light-receiving portion of the photo-coupler 43 is connected at one end thereof to a common connection point of the resistors 40 and 41, and is connected at the other end thereof to the source terminal of the MOSFET 4A.

The comparator 44 has a non-inverting input terminal connected to a connection point between the timer capacitor 47 and the constant-current source 48, and has an inverting input terminal that is applied with a preset reference voltage Vr1. The comparator 45 has a non-inverting input terminal connected to a connection point between the timer capacitor 47 and the constant-current source 48, and has an inverting input terminal that is applied with the output signal from the output detecting circuit 6.

The output detecting circuit 6 is such that two resistors 6A and 6B are connected in series between the output terminals OUT, and an inverting input terminal of an operational amplifier 6D is connected to a common connection point of the resistors 6A and 6B. The operational amplifier 6D is applied with a preset reference voltage Vr2 through a non-inverting input terminal, and has an output terminal and an inverting input terminal that are connected to each other via a resistor 6C. An output signal of the operational amplifier 6D is sent to an inverting input terminal of the comparator 45 in the rectifier circuit 4.

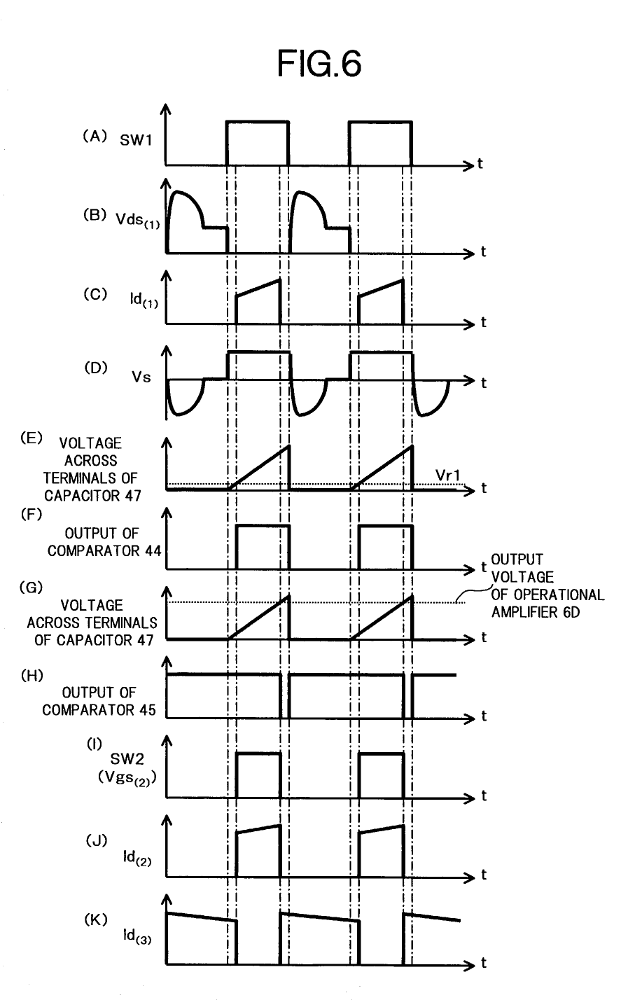

Here, the operation of the third embodiment will be described with reference to a timing diagram of FIG. 6.

In the switching-type DC-DC converter of the above constitution, the MOSFET 3A on the primary side performs the ON/OFF operation according to the first control signal SW1 as shown in (A) of FIG. 6 like in the case of the first embodiment, so that the DC input voltage Vi which was applied to the input terminals IN and has passed through the input filter circuit 1, is converted into an AC voltage and then, is lowered or is raised by the transformer 2. At this moment, when the first control signal SW1 has the low level, since the photo-coupler 42 is turned ON (emits light), the charging to the timer capacitor 47 by the constant-current source 48 is discontinued. When the first control signal SW1 is changed to the high level, the photo-coupler 42 is turned OFF (emits no light) and the timer capacitor 47 is charged with a constant current. Thus, the timer capacitor 47 is charged while the photo-coupler 42 is turned ON and OFF according to the first control signal SW1, so that the voltage across the terminals of the timer capacitor 47 is changed like saw-teeth in synchronism with the first control signal SW1 as shown in (E) and (G) of FIG. 6. The rate (inclination) of change of when the voltage across both terminals of the timer capacitor 47 is increased, remains constant.

The comparator 44 compares the voltage across the terminals of the timer capacitor 47 with the reference voltage Vr1 for the charging operation on the timer capacitor 47. When the voltage across the terminals of the timer capacitor 47 is lower than the reference voltage Vr1, the comparator 44 generates an output of the low level as shown in (F) of FIG. 6. Then, the photo-coupler 43 is turned ON, so that the gate-source voltage Vgs of the MOSFET 4A on the secondary side becomes zero, and the MOSFET 4A is turned OFF. Then, when the timer capacitor 47 is charged and the voltage across the terminals thereof becomes the reference voltage Vr1 or more, the output of the comparator 44 generates is changed to the high level, so that the photo-coupler 43 is turned OFF and the MOSFET 4A is turned ON. Thereby, after the MOSFET 3A on the primary side is turned ON, the MOSFET 4A of the secondary side is turned ON with a delay of fixed period of time. The delay time from when the MOSFET 3A on the primary side is turned ON until when the MOSFET 4A on the secondary side is turned ON, is required to be longer than the falling time of the drain-source voltage Vds₍₁₎ of the MOSFET 3A on the primary side, and the setting of the delay time can be made by adjusting the reference voltage Vr1.

The comparator 45 compares the voltage across the terminals of the timer capacitor 47 with the output voltage from the operational amplifier 6D monitoring the output voltage Vo. When it is detected in the output detecting circuit 6 that the output voltage Vo has exceeded a required value, the output voltage of the operational amplifier 6D becomes smaller than the voltage across the terminals of the timer capacitor 47, so that the output of the comparator 45 is changed to the low level, the photo-coupler 43 is turned ON and the MOSFET 4A is turned OFF. When the MOSFET 3A on the primary side is tuned OFF as a result that the MOSFET 4A on the secondary side that is turned OFF, since the voltage across the terminals of the timer capacitor 47 becomes smaller than the output voltage of the operational amplifier 6D, the output of the comparator 45 becomes the high level, and the photo-coupler 43 is turned OFF. At this moment, however, the MOSFET 3A on the primary side is OFF, and the transformer 2 is inverted, so that the gate voltage of the MOSFET 4A on the secondary side becomes zero or a negative potential. Therefore, the MOSFET 4A remains OFF. Then, when the MOSFET 3A on the primary side is turned ON again, a forward direction potential is applied to the output of the transformer 2, and the voltage divided by the resistors 40, 41 is applied to the gate terminal of the MOSFET 4A which is then turned ON.

Thus, also in the third embodiment, there are obtained the function and effect same as those in the first embodiment, and thus, it is possible to realize a switching-type DC-DC converter with a relatively simply constitution and a low loss.

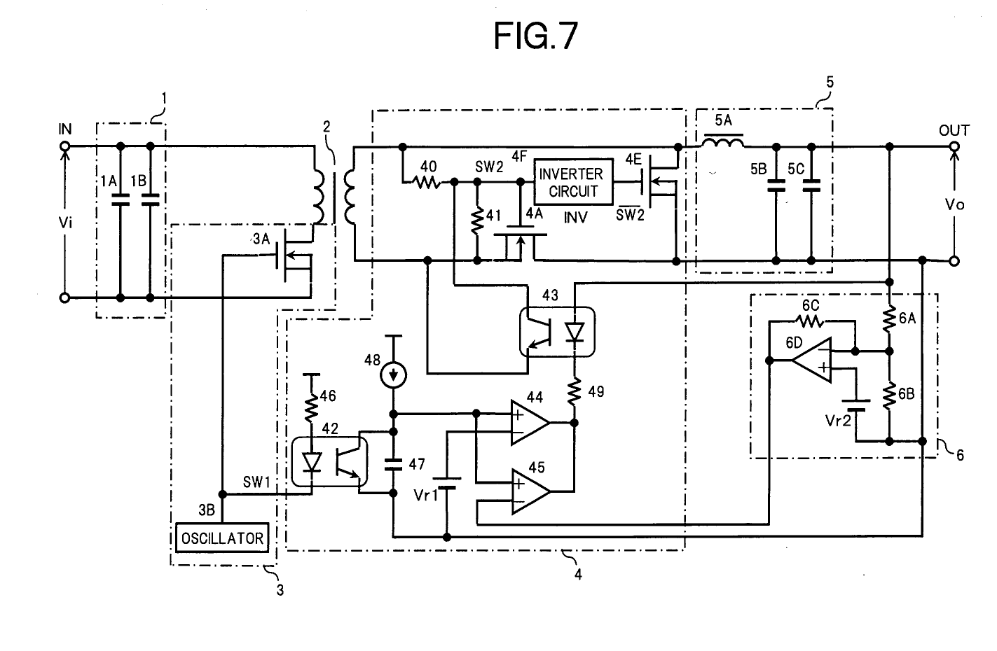

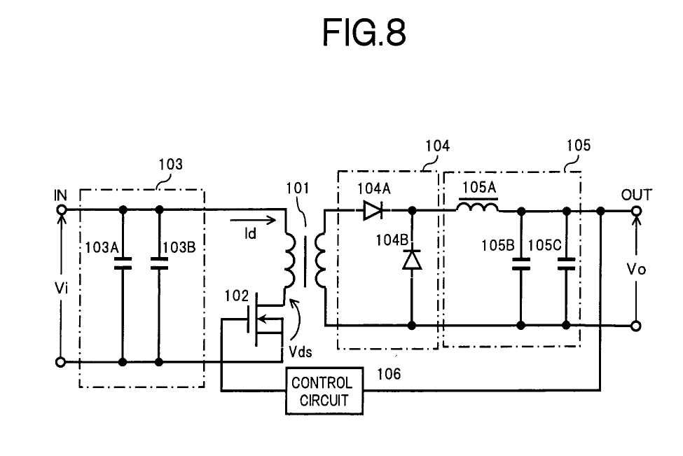

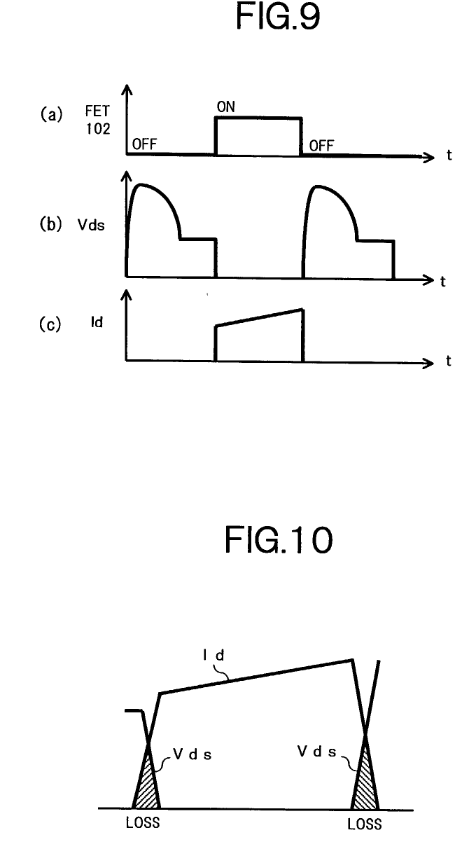

In the above-mentioned third embodiment, the rectifier circuit is constituted using the commutating diode 4B. However, it is also possible to decrease the loss in the rectifier circuit 4 using the MOSFET instead of the commutating diode 4B like in the second embodiment. A specific circuit configuration of this case is shown in FIG. 7. The commutating MOSFET 4E substituted for the commutating diode 4B is controlled for its switching operation according to the second control signal inverted by the inverter circuit 4F like in the second embodiment.

Although the above-mentioned embodiments have used the MOSFET as a switching element, the present invention is no limited thereto and a bipolar transistor or a junction FET may be used as a switching element.

Industrial Applicability:

The present invention has a great industrial applicability to various kinds of electronic and electric devices (e.g., data communication equipment, computers and peripheral equipment) requiring the supply by a low loss and stable DC power source.

What is claimed is:

1. A switching-type DC-DC converter comprising: AC converting means for converting a DC input voltage into an AC voltage by the ON/OFF operation of a switching element, transforming means for transforming the voltage that has been converted into the AC voltage by said AC converting means, rectifying means for rectifying the voltage transformed by said transforming means, and smoothing means for smoothing the voltage rectified by said rectifying means to output a DC output voltage;
wherein said AC converting means includes a switching unit that uses an active element as the switching element, and a first control signal generating unit that generates a first control signal for switching the active element in said switching unit at a fixed frequency and at a fixed ON/OFF ratio; and
said rectifying means includes a rectifying unit that uses an active element as a rectifying element to rectify the voltage transformed by said transforming means, a commutating unit that commutates a current generated by the energy stored in said smoothing means when the active element in said rectifying unit is turned OFF, a delay unit that generates a delay signal obtained by delaying the first control signal output from said first control signal generating unit by a time longer than a response time of the active element in said switching unit, and a second control signal generating unit that generates a second control signal for turning the active element in said rectifying unit ON in synchronism with the delay signal from said delay unit, the second control signal being adjusted for its ON/OFF ratio so that the output voltage smoothed by said smoothing means becomes a preset value, and an ON-continuation time of the second control signal being set to be shorter than a time obtained by subtracting the delay time in said delay unit from an ON-continuation time of the first control signal.

2. A switching-type DC-DC converter according to claim 1, further comprising output detecting means for detecting an output voltage smoothed by said smoothing means,
wherein said second control signal generating unit generates the second control signal of which the ON/OFF ratio is adjusted according to the result detected by said output detecting means.

3. A switching-type DC-DC converter according to claim 1,
wherein said rectifying means includes the commutating unit constituted by an active element, and an inverting unit that inverts the second control signal output from said second control signal generating unit, and the active element in said commutating unit is subjected to the switching operation according to the second control signal inverted by said inverting unit.
